(19) United States
(12) Patent Application Publication
(10) Pub. No.: US 2007/0196803 A1
(43) Pub. Date: Aug. 23, 2007

(54) OPEN-ARCHITECTURE IMAGE INTERPRETATION COURSEWARE

(75) Inventor: Gregory Robert Goodrich, Falls Church, VA (US)

Correspondence Address: Gregory A. Walters;FISH & RICHARDSON P.C., P.O.BOX 1022, MINNEAPOLIS, MN, 55440-1022, US

(73) Assignee: Security Knowledge Solutions, LLC, Potomac Falls, VA (US)

(21) Appl. No.: 11/383,333

(22) Filed: May 15, 2006

Related U.S. Application Data
(60) Provisional application No. 60/688,372, filed on Jun. 8, 2005.

(51) Int. Cl. G09B 7/00

(52) U.S. Cl. 434/323

(57) ABSTRACT

Image interpretation training is provided to a user by receiving a shareable courseware content package formatted according to an open-architecture courseware standard, the shareable courseware content package further comprising image data, sequence data, user interface data, and assessment data, and generating a learning module based upon the shareable courseware content package and the open-architecture courseware standard. Image interpretation training is also provided by displaying user interface data and the image data to the user in accordance with the sequence data, and receiving a user input indicative of a user interpretation of the image data. Furthermore, image interpretation training is provided by evaluating the user input based upon the assessment data, as evaluation data, and reporting the evaluation data.

### CROSS-REFERENCE TO RELATED APPLICATIONS

This application claims the benefit of U.S. Provisional Patent Application No. 60/688,372, filed Jun. 8, 2005, which is incorporated by reference herein.

### BACKGROUND OF THE INVENTION

1. Field of the Invention

The present disclosure generally relates to image interpretation and, more particularly, relates to image interpretation courseware formatted according to an open-architecture courseware standard.

2. Description of the Related Art

Security personnel, such as airport checkpoint ‘screeners,’ typically require image interpretation training in order to properly perform their duties. Image interpretation training prepares the screeners to identify suspect objects included in cargo, baggage, on a person, or any other items that are passed through security inspection equipment, such as an X-ray scanner. Proper training requires that knowledge be transferred from a subject matter expert (“SME”) to the screener. Such a knowledge transfer often makes providing the training logistically difficult, since the screeners must either physically go to a central location to interact with the SME, or the SME must be sent to the screener.

‘E-learning’ allows SME-developed content to reach a broad audience, overcoming some of the logistical issues associated with traditional, in-person training. However, current e-learning products for image interpretation training are often not network enabled, requiring the products to be installed directly on a workstation, which further requires that a technician to set up a computer with the training materials on site. In other cases, image interpretation training occurs in an on-the-job training (“OJT”) setting, however this type of training typically occurs at working security inspection equipment, requiring the screeners to be located at a functioning checkpoint when the baggage is scanned. This requirement limits the number of people capable of being trained at a time, and also prevents the training from being integrated with currently-available learning management systems (“LMSs”) that are deployed at many large sites.

Moreover, organizations typically have difficulty collecting data about training programs and screeners that have been trained. Training content used to train the screeners also typically fails to conform to industry standards, and is not often deliverable via an Internet web browser.

### BRIEF SUMMARY OF THE INVENTION

According to one general aspect, a method is recited for providing image interpretation training to a user. The method includes receiving a shareable courseware content package formatted according to an open-architecture courseware standard, the shareable courseware content package further comprising image data, sequence data, user interface data, and assessment data, and generating a learning module based upon the shareable courseware content package and the open-architecture courseware standard. The method also includes displaying user interface data and the image data to the user in accordance with the sequence data, and receiving a user input indicative of a user interpretation of the image data. Furthermore, the method includes evaluating the user input based upon the assessment data, as evaluation data, and reporting the evaluation data.

Implementations may include one or more of the following features. For example, the open-architecture courseware standard may be an Advanced Distributed Learning (“ADL®”) Sharable Content Object Reference Model (SCORM®) standard, an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, a Dublin Core standard, or other open-architecture courseware standard. The shareable courseware content package may be formatted using Extensible Markup Language (“XML”).

The method also may include storing the evaluation data, reporting the evaluation data further includes displaying the evaluation data to the user, and/or transmitting the evaluation data, although in alternate aspects these steps are combined and/or omitted, and/or other steps are added. The shareable courseware content package further may include organization data, administrative data, timing data, mastery data, score data, and/or comment data.

According to another general aspect, a learning management device is recited. The learning management device includes a receiver, the receiver receiving a shareable courseware content package formatted according to an open-architecture courseware standard, the shareable courseware content package further including image data, sequence data, user interface data, and assessment data, and further receiving a user input indicative of a user interpretation of the image data. The learning management device also includes a learning module, the learning module generating a learning module based upon the shareable courseware content package and the open-architecture courseware standard, evaluating the user input based upon the assessment data, as evaluation data, and reporting the evaluation data. Furthermore, the learning management device includes a user interface, the user interface displaying user interface data and the image data to a user in accordance with the sequence data.

According to another general aspect, a LMS is recited, the LMS including a remote content repository, a learning management device, and a user terminal. The remote content repository further includes a remote content repository storage unit, the remote content repository storage unit storing a shareable courseware content package formatted according to an open-architecture courseware standard, the shareable courseware content package further comprising image data, sequence data, user interface data, and assessment data, and a remote content repository transmitter, the remote content repository transmitter transmitting the shareable courseware content package. The learning management device, further includes a learning management device receiver, the learning management device receiver receiving the shareable courseware content package and further receiving a user input indicative of a user interpretation of the image data, a learning module, the learning module generating a learning module based upon the shareable courseware content package and the open-architecture courseware standard, evaluating the user input based upon the assessment data, as evaluation data, and further reporting the evaluation data, and a learning management device transmitter, the learning management device transmitter transmitting the user interface data and the image data to the user terminal in accordance with the sequence data. The user terminal further includes a user terminal receiver, the user terminal receiver receiving the user interface data and the image data, a user interface, the user interface displaying user interface data and the image data to a user, and for inputting the user input, and a user terminal transmitter, the user terminal transmitter transmitting the user input to the learning management device.

Implementations may include one or more of the following features. For example, the learning management device transmitter may transmit the evaluation data, where the user terminal receiver receives the evaluation data and the user interface displays the evaluation data to the user, or the remote content repository may further include a remote content repository receiver receiving and storing the evaluation data. In an alternative aspect, the learning management device transmitter does not transmit the evaluation data.

According to another general aspect, a data structure by which image interpretation training is provided to a user on a remote LMS is recited. The data structure includes a first component formatted according comprising image data, a second component comprising sequence data, a third component comprising user interface data, and a fourth component comprising assessment data. The first through fourth components are formatted according to an open-architecture courseware standard.

According to another general aspect, a computer program product, tangibly stored on a computer-readable medium, for providing image interpretation training to a user is disclosed. The product includes instructions to be performed at learning management device. The instructions are operable to cause a programmable processor to receive a shareable courseware content package formatted according to an open-architecture courseware standard, the shareable courseware content package further comprising image data, sequence data, user interface data, and assessment data, and generate a learning module based upon the shareable courseware content package and the open-architecture courseware standard. The instructions are further operable to display user interface data and the image data to a user in accordance with the sequence data, and receive a user input indicative of a user interpretation of the image data. Moreover, the instructions are operable to evaluate the user input based upon the assessment data, as evaluation data, and report the evaluation data.

Implementations may include one or more of the following features. For example, using any of these arrangements, training may be provided to security screeners to enable the screeners to operate security inspection equipment, such as X-ray machines, while manning security checkpoints. The training may be designed to replicate the day-to-day operations and conditions the screeners face while on the job, and to provide a safe environment while learning how to correctly interpret images of objects potentially containing dangerous goods, such as improvised explosive devices, guns, drugs, and various prohibited items.

A collection of images, data, and other training content may be packaged into one easily consumable vehicle for the delivery of training. For example, the user interface including the training content may be displayed to a screener that is being trained. The user interface may be presented or delivered to the screener, for example, in a web browser. The user interface may simulate a user interface to the screening equipment that is used to generate the images.

The collection of image data and other training content may be packaged into one easily transportable data structure to facilitate the delivery of training, such as a SCORM® compliant shareable content object (“SCO”). One SCO may include the data needed to display an image to a user, and train the user on the proper interpretation of that image. Packaging content in this manner may allow for the easy distribution of training materials, and collection of associated learning modules.

Providing and presenting the learning module facilitates the training of the security screeners. The learning module may be delivered and displayed, for example, on any browser-enabled enabled personal computer (“PC”) using readily-available Internet software, eliminating the need for the security screeners to be located at the actual screening equipment for training. Accordingly, the use of the screening equipment for live screening of baggage is not disrupted for training purposes. Additionally, the actual screening equipment is not operated by untrained screeners, preventing the untrained screeners from mistakenly clearing potentially dangerous items.

Images designed to be used in a training program may be created, stored, and used in many locations. Because the learning module is capable of display in a web browser, web based tools such as hyper-text markup language (“HTML”), the MACROMEDIA FLASH® or the MACROMEDIA® DIRECTOR™ software tools, the SUN MICROSYSTEMS® JAVA® or the SUN MICROSYSTEMS® JAVASCRIPT® software tools, or other web-based tools may be used for learning module authoring, delivery, and display.

The user input may be evaluated based upon the assessment data, as evaluation data (step S307). Utilizing available technology for LMSs, content creation, content delivery (web browsers), databases, and standards like SCORM®, data describing training programs and trainees is collected and retrieved. Such automated data collection alleviates organizational dependency on high dollar technicians and trainers, allowing organizations to save money while making training more readily available at the same time.

The described image interpretation training techniques may be implemented on network based architecture and/or is integrated into third party LMSs. The techniques are used regardless of whether a firewall separates a user from the LMS. The training techniques are compatible with conventional web browsers, so special training software does not need to be installed on computer systems used by the users. In addition, learning modules can be updated and delivered quickly and easily to the user. The techniques may be implemented on an individual PC, in a small or large classroom, over a wide area network, an enterprise system, the Internet, an extranet, an intranet, or any combination thereof.

The details of one or more implementations are set forth in the accompanying drawings and the description below. Other features will be apparent from the description and drawings, and from the claims.

### BRIEF DESCRIPTION OF THE DRAWINGS

Referring now to the drawings, in which like reference numbers represent corresponding parts throughout:

FIG. 1 depicts the exterior appearance of the learning management device;

FIG. 2 depicts an example of an internal architecture of the implementation of FIG. 1;

FIG. 3 is a flow chart depicting a method for providing image interpretation training to a user, according to one arrangement;

FIGS. 4 to 6 illustrate example user interfaces for providing image interpretation training, in the case where the user interface displays the learning module to a user in a web browser;

FIG. 7 illustrates one such example architecture for providing image interpretation training over a network;

FIG. 8 illustrates an additional exemplary architecture for providing image interpretation training on a standalone personal computer or workstation used by a single user;

FIG. 9 is a block diagram illustrating an additional exemplary architecture for delivering image interpretation training;

FIG. 10 illustrates an example user interface as a user interacts with a training image, in a state where the user has not yet classified the image as benign or suspect;

FIG. 11 illustrates the FIG. 10 user interface in a state where the user has correctly classified the training image 1002;

FIG. 12 illustrates the FIG. 10 user interface in a state where the user has incorrectly classified the image;

FIG. 13 is a flowchart depicting an example process for provide image interpretation training to a user;

FIG. 14 is a flowchart depicting an example process for allowing a user to access the LMS;

FIG. 15 is a flowchart depicting an example process for allowing a user to interact with the data encapsulated by the content package;

FIG. 16 is a flowchart depicting an example process executed by a LMS following the receipt of evaluation data by the LMS;

FIG. 17 is a flowchart illustrating process for providing a user to individual lessons and tests of an image interpretation training learning module;

FIG. 18 is a flowchart depicting one example process flow, and corresponding exemplary image data names, associated with the process of providing image interpretation training;

FIG. 19 depicts an example user interface, in a state where a base image is displayed; and

FIG. 20 depicts an example user interface, in a state where a feedback image is displayed.

### DETAILED DESCRIPTION OF THE INVENTION

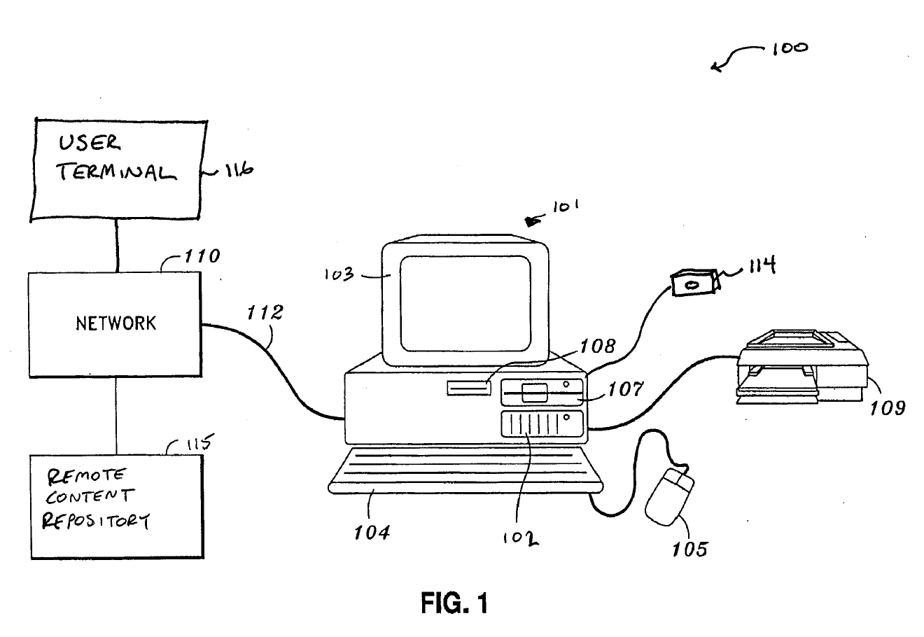

FIG. 1 depicts the exterior appearance of the learning management device according to one exemplary implementation. LMS 100 includes learning management device 101, which in turn includes a computer-readable storage medium, such as fixed disk drive 102, in which is stored a program for providing image interpretation training to a user. As shown in FIG. 1, the hardware environment of LMS 100 includes learning management device 101, display monitor 103 for displaying text and images to a user, keyboard 104 for entering text data and user commands into learning management device 101, mouse 105 for pointing, selecting and manipulating objects displayed on display monitor 103, fixed disk drive 102, removable disk drive 107, tape drive 108, hardcopy output device 109, computer network 110, computer network connection 112, and digital input device 114.

Display monitor 103 displays the graphics, images, and text that comprise the user interface for the software applications used by this arrangement, as well as the operating system programs necessary to operate learning management device 101. A user of learning management device 101 uses keyboard 104 to enter commands and data to operate and control the computer operating system programs as well as the application programs. The user uses mouse 105 to select and manipulate graphics and text objects displayed on display monitor 103 as part of the interaction with and control of learning management device 101 and applications running on learning management device 101. Mouse 105 is any type of pointing device, including a joystick, a trackball, or a touch-pad without departing from the scope of the present invention. Furthermore, digital input device 114 allows learning management device 101 to capture digital images, and is a scanner, digital camera or digital video camera.

The image interpretation training programs and data structures are stored locally on computer readable memory media, such as fixed disk drive 102. In a further aspect, fixed disk drive 102 itself comprises a number of physical drive units, such as a redundant array of independent disks (“RAID”). In a further additional aspect, fixed disk drive 102 is a disk drive farm or a disk array that is physically located in a separate computing unit. Such computer readable memory media allow learning management device 101 to access image data, sequence data, user interface data, assessment data, organization data, administrative data, timing data, mastery data, score data, comment data, or other types of data, computer-executable process steps, application programs and the like, stored on removable and non-removable memory media.

Network connection 112 may be a modem connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. Network 110 may be a LAN network, however in further aspects network 110 is a corporate or government WAN network, or the Internet.

Removable disk drive 107 is a removable storage device that is used to off-load data from learning management device 101 or upload data onto learning management device 101. Removable disk drive 107 may be a floppy disk drive, an IOMEGA® ZIP® drive, a compact disk-read only memory (“CD-ROM”) drive, a CD-Recordable drive (“CD-R”), a CD-Rewritable drive (“CD-RW”), a DVD-ROM drive, flash memory, a Universal Serial Bus (“USB”) flash drive, thumb drive, pen drive, key drive, or any one of the various recordable or rewritable digital versatile disk (“DVD”) drives such as the DVD-Recordable (“DVD-R” or “DVD+R”), DVD-Rewritable (“DVD-RW” or “DVD+RW”), or DVD-RAM. Operating system programs, applications, and various data files, such as image data, sequence data, user interface data, assessment data, organization data, administrative data, timing data, mastery data, score data, comment data, or courseware application programs, are stored on disks. The files are stored on fixed disk drive 102 or on removable media for removable disk drive 107 without departing from the scope of the present invention.

Tape drive 108 is a tape storage device that is used to off-load data from learning management device 101 or upload data onto learning management device 101. Tape drive 108 may be a quarter-inch cartridge (“QIC”), 4 mm digital audio tape (“DAT”), or 8 mm digital linear tape (“DLT”) drive.

Hardcopy output device 109 provides an output function for the operating system programs and applications including the image interpretation training courseware. Hardcopy output device 109 may be a printer or any output device that produces tangible output objects, including textual or image data or graphical representations of textual or image data. While hardcopy output device 109 is preferably directly connected to learning management device 101, it need not be. For instance, in an alternate arrangement of the invention, hardcopy output device 109 is connected via a network interface (e.g., wired or wireless network, not shown).

Although learning management device 101 is illustrated in FIG. 1 as a desktop PC, in further aspects learning management device 101 may include a laptop, a workstation, a midrange computer, a mainframe, or an embedded system. Remote content repository 115 and user terminal 116 each include components with features, functions and structures similar to corresponding components of learning management device 101, described above. Further description of each is therefore omitted for the sake of brevity. In alternate aspects, the functions of remote content repository 115 and/or user terminal 116 are combined with each other or with learning management device 101, or are omitted altogether, such is the case where the user interacts with the image interpretation courseware at the learning management device 101 itself, or where the learning management device 101 is itself the repository for the shareable courseware content packages. Each of these aspects and others are contemplated by this arrangement.

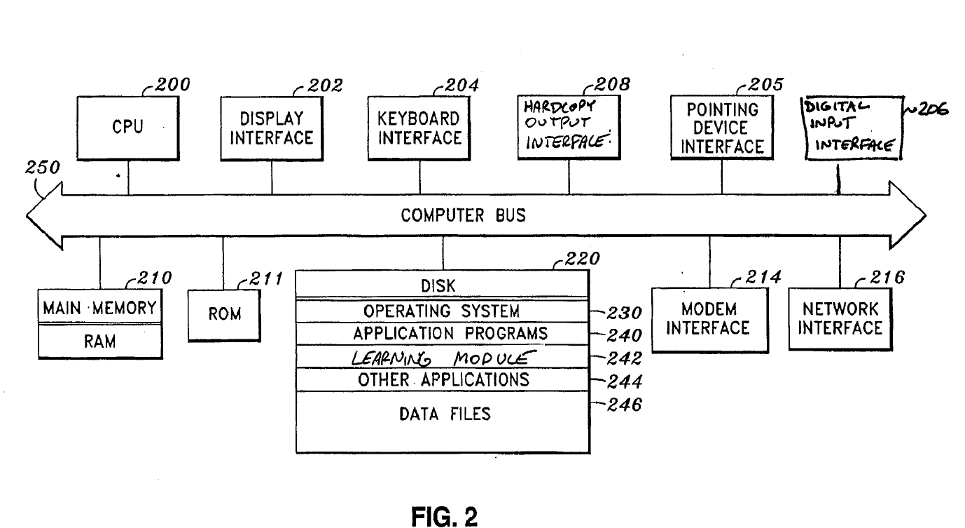

FIG. 2 depicts an example of an internal architecture of the implementation of FIG. 1. The computing environment includes computer central processing unit (“CPU”) 200 where the computer instructions that comprise an operating system or an application, including the learning module applications, are processed; display interface 202 which provides a communication interface and processing functions for rendering graphics, images, and texts on display monitor 103; keyboard interface 204 which provides a communication interface to keyboard 104; pointing device interface 205 which provides a communication interface to mouse 105 or an equivalent pointing device; digital input interface 206 which provides a communication interface to digital input device 114; hardcopy output device interface 208 which provides a communication interface to hardcopy output device 109; random access memory (“RAM”) 210 where computer instructions and data are stored in a volatile memory device for processing by computer CPU 200; read-only memory (“ROM”) 211 where invariant low-level systems code or data for basic system functions such as basic input and output (“I/O”), startup, or reception of keystrokes from keyboard 104 are stored in a non-volatile memory device; disk 220 which can comprise fixed disk drive 102 and removable disk drive 107, where the files that comprise operating system 230, application programs 240 (including learning module applications 242 and other applications 244) and data files 246 are stored; network interface 214 which provides a communication interface to computer network 110 over a modem; and computer network interface 216 which provides a communication interface to computer network 110 over a computer network connection 112. The constituent devices and computer CPU 200 communicate with each other over computer bus 250.

RAM 210 interfaces with computer bus 250 so as to provide quick RAM storage to computer CPU 200 during the execution of software programs such as the operating system application programs, and device drivers. More specifically, computer CPU 200 loads computer-executable process steps from fixed disk drive 102 or other memory media into a field of RAM 210 in order to execute software programs. Data, including image data, sequence data, interface data, assessment data, organization data, administrative data, timing data, mastery data, score data, comment data or other data relating to image interpretation courseware, is stored in RAM 210, where the data is accessed by computer CPU 200 during execution.

Also shown in FIG. 2, disk 220 stores computer-executable code for a windowing operating system 230, application programs 240 such as word processing, spreadsheet, presentation, graphics, image interpretation training, gaming, or other applications. Disk 220 also stores the learning module applications 242 which provide for image interpretation training.

Although it is possible to provide image interpretation training to a user using the above-described implementation, it is also possible to implement the functions according to the present invention as a dynamic link library (“DLL”), or as a plug-in to other application programs such as an Internet web-browser such as the MICROSOFT® Internet Explorer web browser.

Computer CPU 200 is one of a number of high-performance computer processors, including an INTEL® or AMD® processor, a POWERPC® processor, a MIPS® reduced instruction set computer (“RISC”) processor, a SPARC® processor, a HP ALPHASERVER® processor or a proprietary computer processor for a mainframe, without departing from the scope of the present invention. In an additional arrangement, computer CPU 200 in learning management device 101 is more than one processing unit, including a multiple CPU configuration found in high-performance workstations and servers, or a multiple scalable processing unit found in mainframes.

Operating system 230 is: MICROSOFT® WINDOWS NT®/WINDOWS® 2000/WINDOWS® XP Workstation; WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers, MAC OS® X for POWERPC® based workstations and servers; or a proprietary operating system for mainframe computers.

While FIGS. 1 and 2 illustrate one possible implementation of a computing system that executes program code, or program or process steps, configured to provide image interpretation to a user, other types of computing or LMSs are also be used as well.

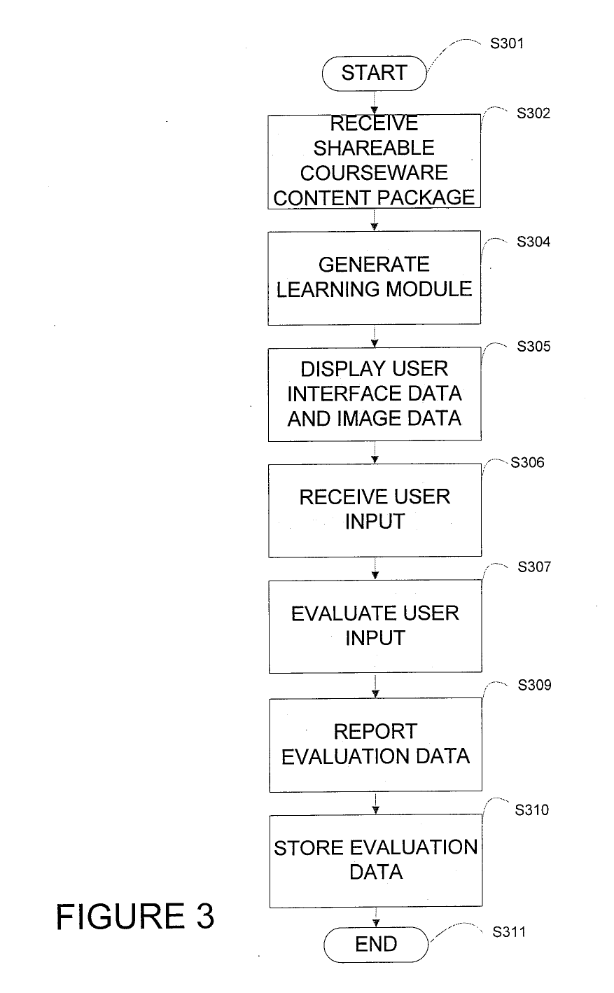

FIG. 3 is a flowchart illustrating a method for providing image interpretation training to a user according to one implementation. Briefly, the method includes receiving a shareable courseware content package formatted according to an open-architecture courseware standard, the shareable courseware content package further comprising image data, sequence data, user interface data, and assessment data, and generating a learning module based upon the shareable courseware content package and the open-architecture courseware standard. The method also includes displaying user interface data and the image data to the user in accordance with the sequence data, and receiving a user input indicative of a user interpretation of the image data. Furthermore, the method includes evaluating the user input based upon the assessment data, as evaluation data, and reporting the evaluation data.

Using this method, training is provided to security screeners to enable the screeners to operate security inspection equipment, such as X-ray machines, while manning security checkpoints. The training is designed to replicate the day-to-day operations and conditions the screeners face while on the job, and to provide a safe environment learning how to correctly interpret images containing dangerous goods, such as improvised explosive devices, guns, drugs, and various prohibited items.

In more detail, the process begins (step S301), and a shareable courseware content package formatted according to an open-architecture courseware standard is received (step S302), the shareable courseware content package further comprising image data, sequence data, user interface data, and assessment data.

The term “open-architecture” is intended to describe an architecture whose specifications are public, such as officially-approved standards as well as privately designed architectures whose specifications are made public by the designers. An open-architecture is antonymous to a closed, or proprietary architecture. Furthermore, the term “courseware” is intended to describe to software designed to be used in an educational program or setting. Examples of open-architecture courseware standards are ADL® SCORM® standards (including SCORM® Standard Version 1.2 and SCORM® Standard Version 2004), AICC® standards, IEEE® LTSC standards, IMS Global Learning Consortium standards, PROMETEUS standards, or Dublin Core standards. The user accesses the training through an LMS, such as an AVILAR® LMS.

The shareable courseware content package is formatted using XML. Within open-architecture courseware standards such as SCORM®, XML is used as metadata that is packaged in a manifest which is part of the content package or learning object. The manifest controls the sequencing, the interactions and the listing of assets or data, learning modules, content packages, and SCOs. A SCORM® manifest is an XML file, such as “IMSMANIFEST.XML”, that describes a learning module or content package. The manifest file provides metadata such as the title and description of the learning module, sequence data indicating the sequence of the SCOs or data within the content package, the name of the launch file for each SCO or learning module, and a list of all the data files in the learning module. The shareable courseware content package further includes organization data, administrative data, timing data, mastery data, score data, and/or comment data.

In one example arrangement relating to a learning management device, the learning management device includes a receiver, the receiver receiving the shareable courseware content package.

In a second example arrangement relating to an LMS, the LMS includes a remote content repository, a learning management device, and a user terminal. The remote content repository further includes a remote content repository storage unit, the remote content repository storage unit storing the shareable courseware content package. The remote content repository further includes a remote content repository transmitter, the remote content repository transmitter transmitting the shareable courseware content package. The learning management device further includes a learning management device receiver, the learning management device receiver receiving the shareable courseware content package and further receiving a user input indicative of a user interpretation of the image data.

According to this second arrangement, the learning module is transferred to the user terminal on which the user interface exists, over a network connecting the user terminal and the LMS and/or the remote content depository. When the content package is too large to be easily downloaded over a network, the content package or parts thereof are distributed to the computer system on other media, such as a CD or a DVD, or as a pre-loaded download that is scheduled for a time at which the learning module is more easily downloaded.

In a third example arrangement, a data structure by which image interpretation training is provided to a user on a remote LMS is contemplated. The data structure includes a first component formatted according comprising image data, a second component comprising sequence data, a third component comprising user interface data, and a fourth component comprising assessment data. The first through fourth components are formatted according to an open-architecture courseware standard.

The learning module, or training content, is packaged into one easily transportable data structure to facilitate the delivery of training, such as a SCORM® compliant SCO. One SCO includes the data needed to display an image to a user, and train the user on the proper interpretation of that image. Packaging content in this manner allows for the easy distribution of training materials, and collection of associated learning modules.

A learning module is generated based upon the shareable courseware content package and the open-architecture courseware standard (step S304). Since the shareable courseware content package is formatted according to an open architecture courseware standard, an LMS is able to generate a learning module, which delivers the training content, by extracting the data packaged or encapsulated in the content package, and the associated sequence data, without using a proprietary or custom back-end system, saving time and money, and increasing transportability of the training content.

User interface data and the image data are displayed to the user in accordance with the sequence data (step S305). For example, a user interface including the learning module is displayed to a screener that is being trained, where the user interface is presented or delivered to the screener in a web browser. A user interface simulates the screening equipment that is used to generate the images. The simulation of the screening equipment is intended to mirror the functionality of the actual screening equipment, where image processing functionality typical of an inspection machine is included in the user interface/simulator.

In the example arrangement relating to the learning management device, the learning management device includes a user interface, the user interface displaying user interface data and the image data to a user in accordance with the sequence data. A user input indicative of a user interpretation of the image data is received (step S306). When the user selects on one of the image processing controls, instead of retrieving a static image, the learning module calls a function to process the image. For example, if the user wishes to see a black and white image to assist in image interpretation, the user selects the corresponding control, which would launch the code to manipulate the image they are viewing. On top of traditional web tools like the MACROMEDIA FLASH® software tool and the MACROMEDIA® DIRECTOR™ software tool, other programming tools, such as the MICROSOFT®.NET operating system platform, the SUN MICROSYSTEMS® JAVA® or the SUN MICROSYSTEMS® JAVASCRIPT® software tools, or programming languages such as C or C++, and/or the MICROSOFT® VISUAL BASIC® programming language.

In the example arrangement relating to the LMS, the learning management device includes a learning management device transmitter, the learning management device transmitter transmitting the user interface data and the image data to the user terminal in accordance with the sequence data. The user terminal further includes a user terminal receiver, the user terminal receiver receiving the user interface data and the image data, a user interface, the user interface displaying user interface data and the image data to a user, and for inputting the user input, and a user terminal transmitter, the user terminal transmitter transmitting the user input to the learning management device.

Providing and presenting the learning module facilitates the training of the security screeners. The learning module is delivered and displayed, for example, on any browser-enabled personal computer (“PC”) using readily-available Internet software, eliminating the need for the security screeners to be located at the actual screening equipment for training. Accordingly, the use of the screening equipment for live screening of baggage is not disrupted for training purposes. Additionally, the actual screening equipment is not operated by untrained screeners, preventing the untrained screeners from mistakenly clearing potentially dangerous items.

Images designed to be used in a training program are created, stored, and used in many locations. Because the learning module is capable of display in a web browser, web based tools such as hyper-text markup language (“HTML”), the MACROMEDIA FLASH® or the MACROMEDIA® DIRECTOR™ software tools, the SUN MICROSYSTEMS® JAVA® or the SUN MICROSYSTEMS® JAVASCRIPT® software tools, or other web-based tools are used for learning module authoring, delivery, and display.

The described image interpretation training techniques is implemented on network based architecture and/or is integrated into third party LMSs. The techniques are used regardless of whether a firewall separates a user and the LMS. The training techniques are compatible with conventional web browsers, so special training software does not need to be installed on computer systems used by the users. In addition, learning modules can be updated and delivered quickly and easily to the user. The techniques are implemented on an individual PC, in a small or large classroom, over a Wide Area Network, an enterprise system, the Internet, an extranet, an intranet, or any combination thereof.

The user input is evaluated based upon the assessment data, as evaluation data (step S307). Utilizing available technology for LMSs, content creation, content delivery (web browsers), databases, and standards like SCORM®, data describing training programs and trainees is collected and retrieved. Such automated data collection alleviates organizational dependency on high dollar technicians and trainers, allowing organizations to save money while making training more readily available at the same time.

In the example arrangement relating to the learning management device, the learning management device also includes a learning module, the learning module generating a learning module based upon the shareable courseware content package and the open-architecture courseware standard, and evaluating the user input based upon the assessment data, as evaluation data, and reporting the evaluation data. In the example arrangement relating to the LMS, the learning management device also includes a learning module, the learning module generating a learning module based upon the shareable courseware content package and the open-architecture courseware standard, evaluating the user input based upon the assessment data, as evaluation data, and further reporting the evaluation data.

The evaluation data is reported (step S309). Reporting the evaluation data further includes displaying the evaluation data to the user, and/or transmitting the evaluation data. Since the content package includes images of at least one object to be screened, such as a single suitcase, and potentially tens of objects to be screened, such as several dozen suitcases, reporting of the evaluation data occurs after receiving the user input or image interpretation for a single image, or after several or all of the images have been interpreted. As such, in one example, an LMS receives evaluation data after the user correctly or incorrectly identifies a single threat, where the LMS modifies the sequence or difficulty of subsequent images, and/or extends or shortens the length of the learning module after receiving the evaluation data. In another example, such as the case where the learning module is intended to be the same for all users, the LMS receives evaluation data after each user interprets all the images. In any regard, it is contemplated that in certain circumstances training will occur by presenting the users with series of learning modules, each learning module presenting images of a few objects, or one object, to be interpreted, and in other cases the user will be presented with a few learning modules or one learning module, where each learning module presents images of several objects, several tens of objects, or several hundreds of objects or more, to be interpreted.

In the example arrangement relating to the LMS, the learning management device transmitter transmits the evaluation data, where the user terminal receiver receives the evaluation data and the user interface displays the evaluation data to the user, or the remote content repository further includes a remote content repository receiver receiving the evaluation data and the remote content repository storage unit storing the evaluation data. In an alternative aspect, the learning management device transmitter does not transmit the evaluation data.

The evaluation data is stored (step S310) and the process ends (step S311).

An additional arrangement provides for a computer program product, tangibly stored on a computer-readable medium, where the computer program product provides image interpretation training to a user, the product including instructions to be performed at learning management device, is recited. The instructions are operable to cause a programmable processor to receive a shareable courseware content package formatted according to an open-architecture courseware standard, the shareable courseware content package further comprising image data, sequence data, user interface data, and assessment data, and generate a learning module based upon the shareable courseware content package and the open-architecture courseware standard. The instructions are further operable to display user interface data and the image data to a user in accordance with the sequence data, and receive a user input indicative of a user interpretation of the image data. Moreover, the instructions are operable to evaluate the user input based upon the assessment data, as evaluation data, and report the evaluation data.

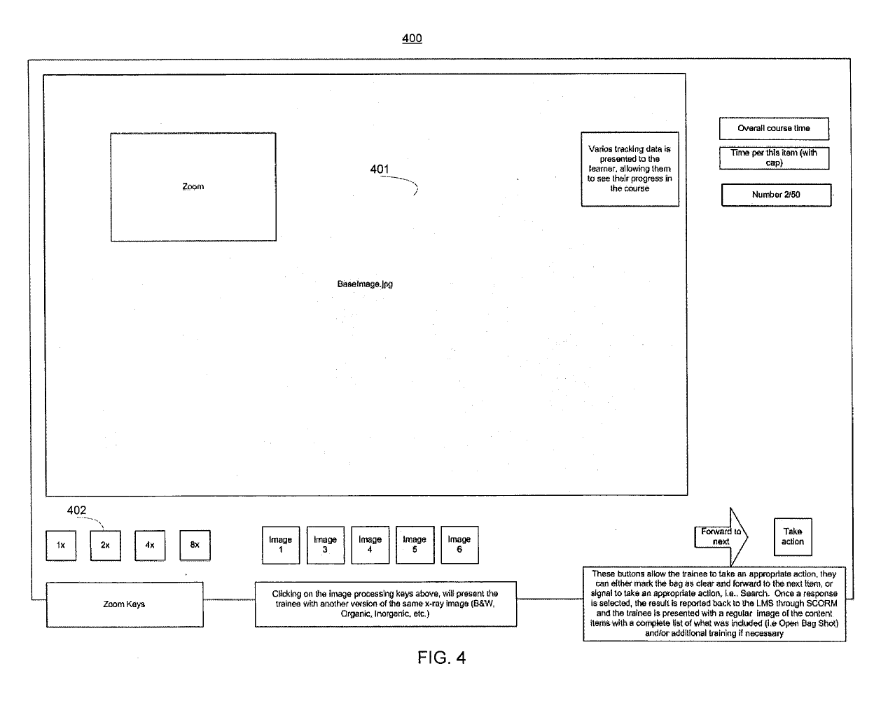

FIGS. 4 to 6 illustrate example user interfaces for providing image interpretation training, in the case where the user interface displays the learning module to a user in a web browser. In more detail, the content package is used to generate a learning module, using user interface data and image data, where the user interface data and the image data are displayed on user interface 400. The user interface data simulates a user interface to the security screening equipment that the user is being trained to use.

In this example, and as depicted in FIG. 4, the user interface displays an image area 401, labeled “BASEIMAGE.JPG”, in which an image on which the user is being trained is displayed. The image initially displayed in the image area is a base image, or unprocessed version of the image which the user is being trained to interpret.

The user interface includes multiple zoom keys, such as zoom key 402, which are labeled “1×,” “2×,” 4×,” and “8×, ” which enable the user to zoom in on portions of the image displayed within the image area. When selected, each of the zoom keys magnifies the displayed image by a particular amount. For example, selecting the zoom key 402 (labeled “2×”) magnifies the displayed image by a factor of two. The user interface includes one zoom key for each magnification that is provided by the user interface of the security screening equipment that the illustrated interface is intended to simulate.

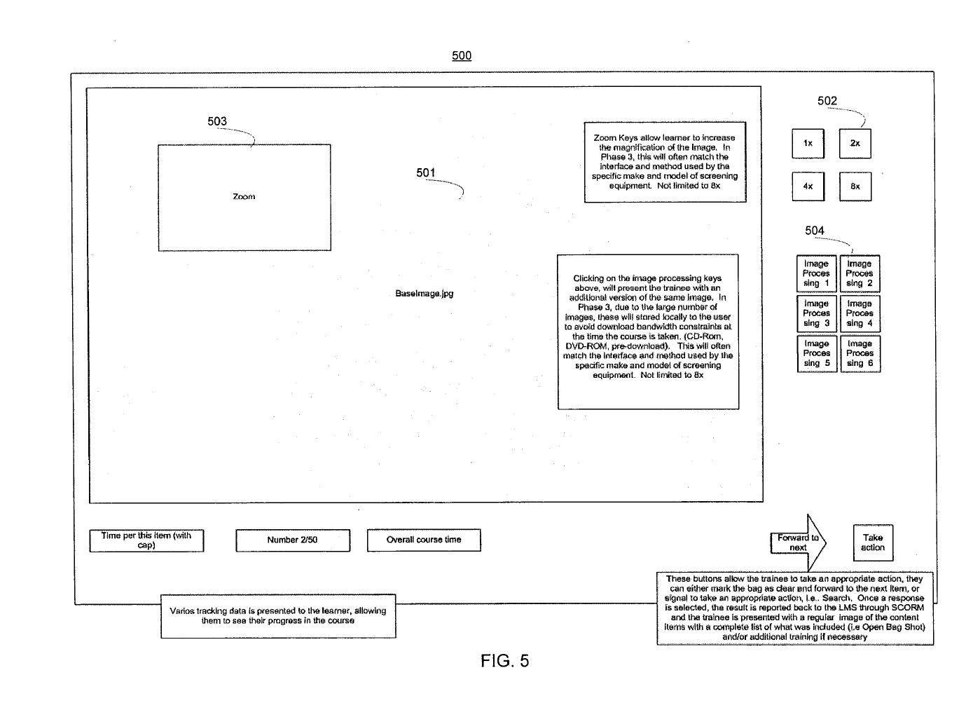

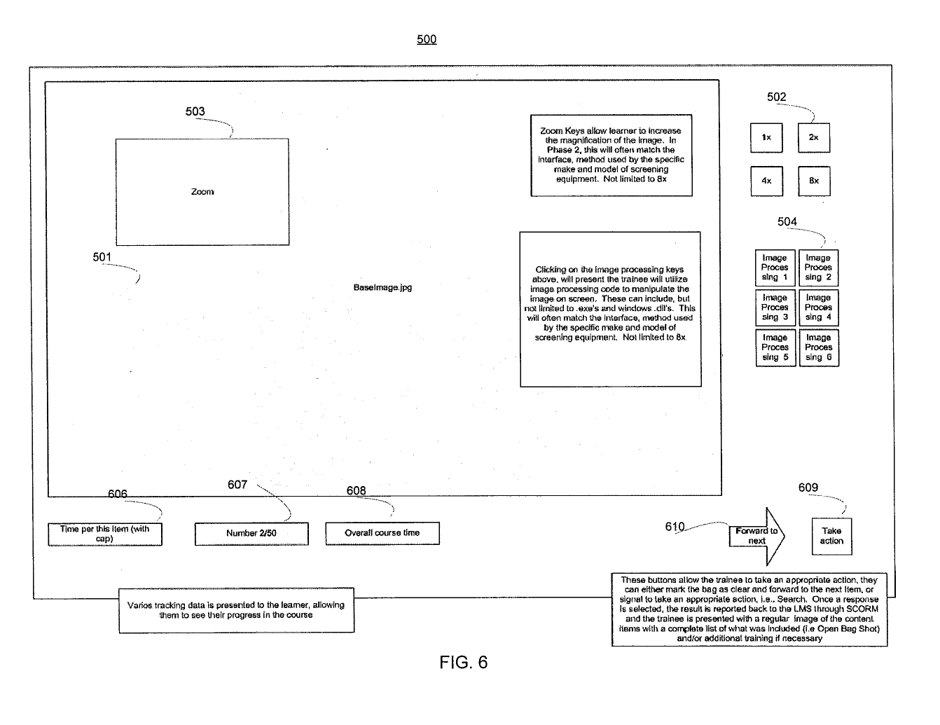

As illustrated in FIGS. 5 and 6, image area 501 of user interface 500 also includes a zoom indicator 503, where the user moves zoom indicator 503 to a position within image area 501. Selecting one of the zoom keys, such as zoom key 502, causes the area of the displayed image within zoom indicator 503 to be magnified by an amount corresponding to the selected zoom key 502.

The user interface also includes multiple image processing keys, such as image processing key 504. Selecting one of the image processing keys causes a processed version of the image on which the user is being trained to be displayed in image area 501. For example, image processing key 504 causes a black-and-white version of the image to be displayed in image area 501, while selecting another one of the image processing keys causes an inverted version of the image to be displayed. Other image processing keys cause a colored version, an x-ray version, an inorganic version, an organic version, or another processed version of the image to be displayed. The user interface includes one image processing key for each version of the image that is provided by the user interface to the security screening interface that the illustrated interface is intended to simulates, although more than one image processing key could also be used for each version of the image, or several versions of the image share a common image processing key.

Information describing the image on which the user is being trained is also accessible via the user interface. For example, in the case where the image is of a truck that is loaded with various pieces of cargo, the user interface enables the user to access a shipping manifest that identifies the cargo within the truck.

The user interface also includes an indication of the user's training progress. For example, the user interface includes indicator 606 indicating an amount of elapsed time for which the user has been viewing the current image on which the user is being trained. The user interface also includes an indicator 607 indicating of the number of images the user has already interpreted, a number of images remaining, and/or a total number of images to be interpreted. Furthermore, the user interface also includes an indicator 608 indicating of a total amount of time allotted for image interpretation training.

The user interface also includes controls, such as control 609, for identifying the image displayed within the image area, such as to classify the image as ‘benign’ or ‘suspect.’ Typically, a user would classify the image as ‘suspect’ when the image, or one of the processed versions of the image, is interpreted as including evidence of suspect, dangerous or prohibited contents. Alternatively, the user would classify the image as ‘benign’ when the image and/or the processed versions of the image do not include evidence of suspect, dangerous or prohibited contents.

As an example, a control such as ‘forward to next’ control 610 is selected to classify the image as benign, and a control, such as ‘take action’ control is selected to classify the image as suspect. Selecting ‘forward to next’ control 610 control or the ‘take action’ control 609 causes a regular, unprocessed version of the image to be displayed in the image area, and/or a list of the contents of the image is displayed on the user interface. Alternatively, selecting ‘forward to next’ control 610 or ‘take action’ control 609 causes another image to be displayed in image area 501 for the user, or learner, to interpret.

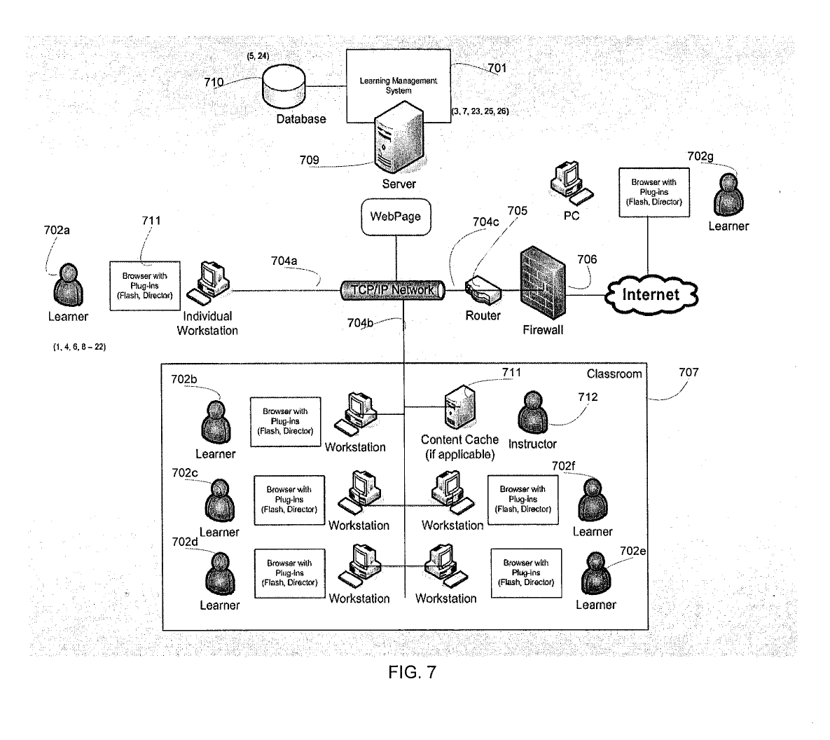

FIGS. 7 to 9 illustrate several examples of architectures in which image interpretation training is implemented. It is contemplated that an entity providing the image interpretation training is enabled to provide a LMS that allows users to access the training over a network, such as the Internet. Accordingly, in one example, a third party LMS, located where the user is trained, provides access to the training, where the training system is implemented either on a computer used by a particular user, or directly on an actual security screening device.

FIG. 7 illustrates one such example architecture for providing image interpretation training over a network. The architecture includes a LMS 701 that provides training content via a learning module to multiple users, such as users 702a to 702g, over one or more networks, such as networks 704a to 704c, that connect the multiple users to LMS 701. The multiple users are connected to LMS 701 directly, such as via network 704a, or through one or more routers 705 and/or firewalls 706, such as via network 704c. The multiple users are at distributed locations, or a common location, such as classroom 707.

LMS 701 maintains a database that includes the learning module, or content package, that is to be provided to users 702a to 702g. LMS 701 also operates web server 709 through which users 702a to 702g contact LMS 701. For instance, if user 702a submits a request for image interpretation training to web server 709, LMS 701 retrieves the content package associated with the requested image interpretation training from database 710 and formats the requested learning module as a shareable courseware object, if it is not already stored in such a format, and provides the content package to users 702a.

Each of users 702a to 702g uses a personal computer or workstation, each of which executes a web browser application, such as browser 711. The web browser applications include at least one plug-in application that enables the web browser to display the content package and/or the data included in the content package. For example, FIGS. 4 to 6 exemplify the display of user interface data and image data stored by the shareable courseware content package.

In the case where some or all of the multiple users are trained in a classroom, such as users 702b to 702f in classroom 707, the classroom includes a content cache, such as content cache 711, that caches the learning module provided to at least one of the users included in the classroom by LMS 701. Caching the content packages eliminate the need to transfer multiple copies of the content package from LMS 701 for each user in the classroom. In addition, it is also helpful to include a SME, such as instructor 712, within the classroom to assist the users.

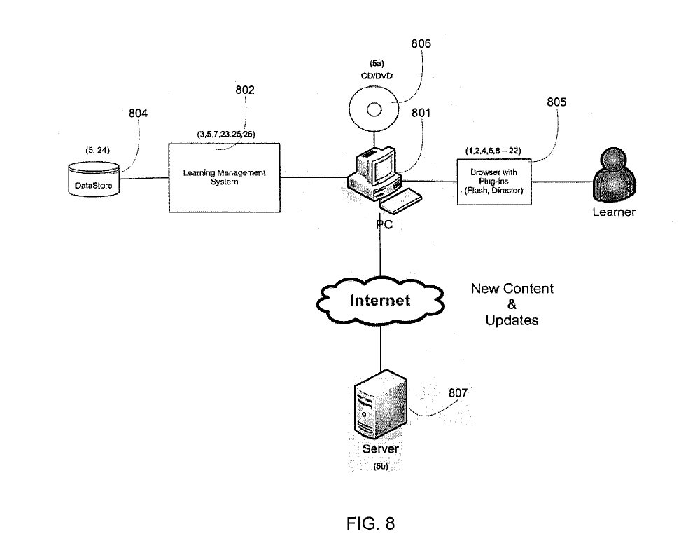

FIG. 8 illustrates an additional exemplary architecture for providing image interpretation training on a standalone personal computer or workstation used by a single user. In more detail, workstation 801 includes LMS component 802 that accesses a content repository 804, or data store of content packages. LMS 802 is similar in function LMS 701 described, supra, with respect to FIG. 7. Because LMS 802 is included as a component of workstation 801, workstation 801 does not access LMS 802 via a web server, as was the case with the example architecture described in FIG. 7. Workstation 801 also includes web browser application 805, which is similar in function to web browser application 711.

Workstation 801 also accesses portions of the learning module via the content packages, from removable storage medium 806 that is associated with workstation 801, where removable storage medium 806 is a CD, a DVD, a flash memory card, or other known type of removable storage medium. Workstation 801 is also connected to content server 807 through one or more networks, such as the Internet. Content 807 server provides workstation 801 with additional learning modules or content packages, such that additional content packages are stored in and accessed from content repository 804.

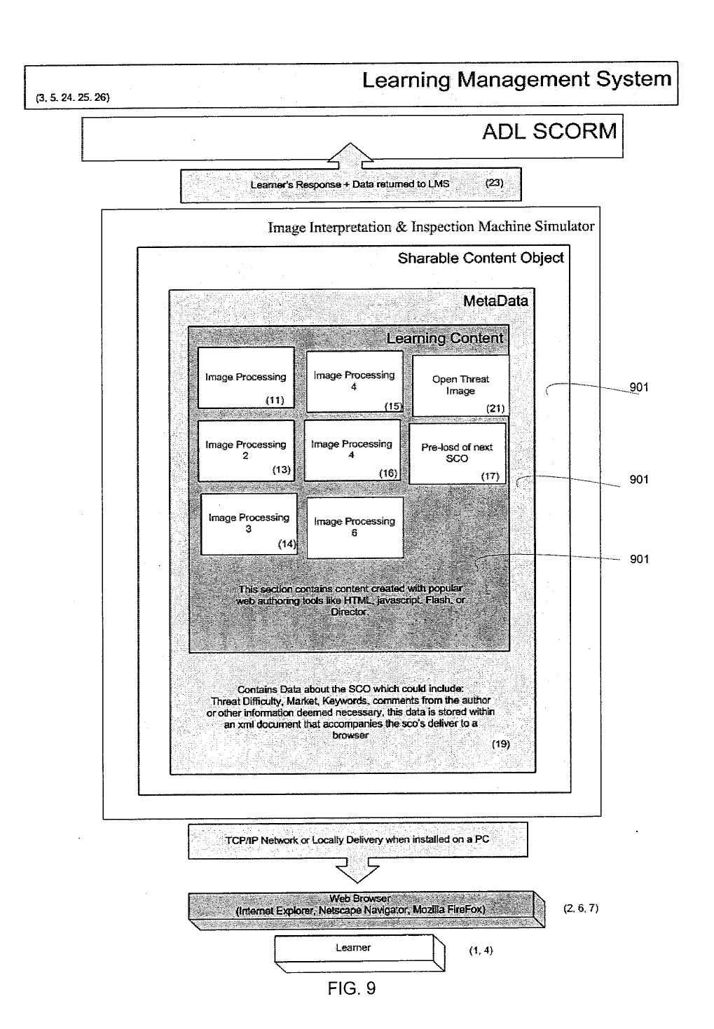

FIG. 9 is a block diagram illustrating an additional exemplary architecture for delivering image interpretation training. In this architecture, shareable courseware objects, such as content package 901, include metadata 902 encapsulating data 901, which includes image data, sequence data, user interface data, assessment data, and the like. Content package 901 is passed between a LMS and a web browser which is capable of displaying the encapsulated data to a user. The data 901 includes an image on which the user is to be trained, and one or more processed variations of the image. In addition, the data 901 includes another image on which the user is to be trained by a learning module that is displayed after the current learning module.

Metadata 902 encapsulates information describing the learning module and the training content, indicating, for example, the author of the learning module, an indication of a difficulty of the learning module, an indication of whether the image is benign or suspect, keywords describing the learning module and the training content, and comments from the author. The metadata is stored within an XML document that is associated with the learning module, although in alternate aspects XML is not used. The learning module is intended to simulate an inspection machine that the user is being trained to use.

The learning module is transferred to a user‘s web browser directly, or through a network. Information describing the user's interaction with the learning module is provided to the LMS, which monitors and controls the user's training to conform to an open-architecture courseware standard. The LMS determines which learning modules are provided to the user based on user input, and also determines whether the user has been trained completely based on the evaluation data.

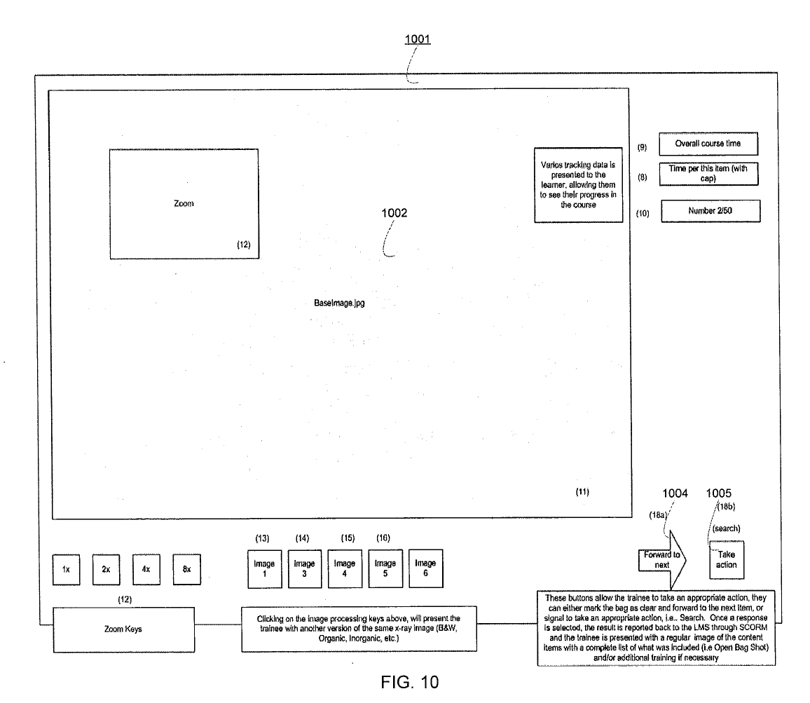

FIGS. 10 to 12 provide additional illustrations of an example user interface for providing image interpretation training, with similar functionality and structure to the user interfaces illustrated in FIGS. 4 to 6. FIG. 10, for example, illustrates user interface 1001 as a user interacts with training image 1002, in a state where the user has not yet classified the image as benign or suspect. The user selects ‘forward to next’ control 1004 control to classify the substance of training image 1002 as benign, or the ‘take action’ control to classify the substance of training image 1002 as suspect. The underlying LMS makes a determination as to whether the user has correctly classified the image as benign or suspect, and an indication this evaluation is displayed on the user interface.

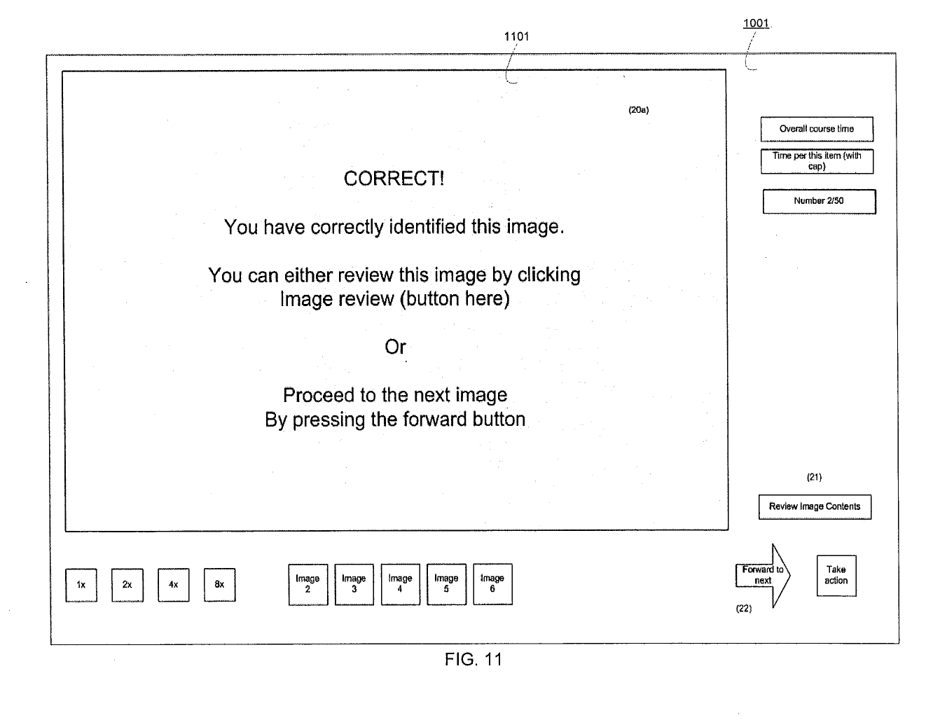

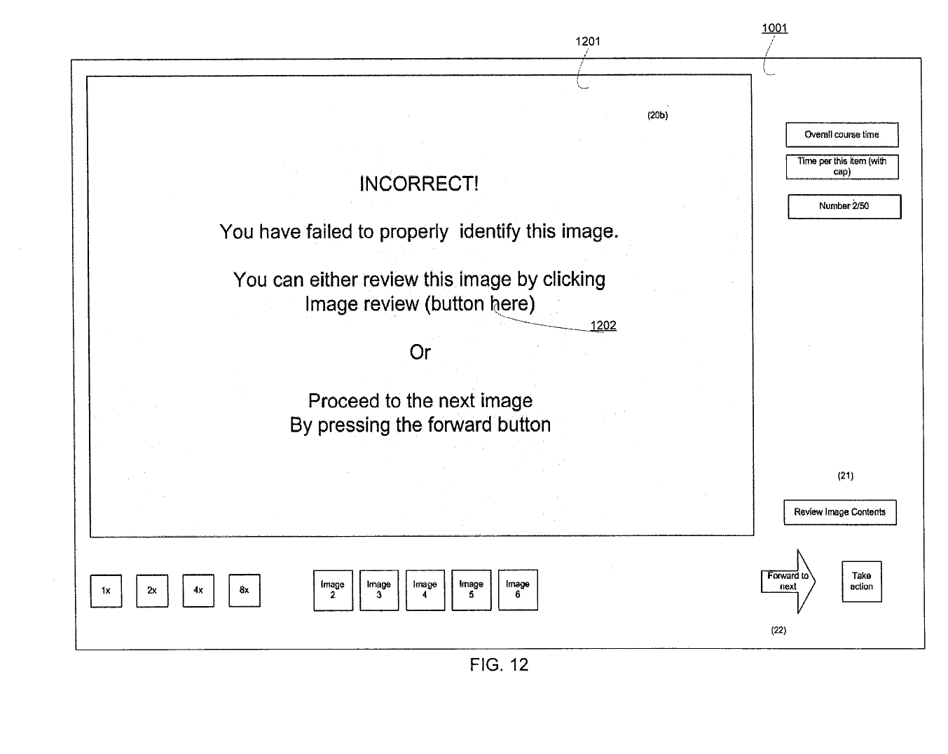

FIG. 11 illustrates user interface 1001 in a state where the user has correctly classified training image 1002, and FIG. 12 illustrates user interface 1001 in a state where the user has incorrectly classified the image. As depicted, the evaluation data, or a message 1101 or 1201 indicative of the evaluation data replaces training image 1002 in the image area of user interface 1001. Message 1101 or 1201 includes options or instructions, such as control 1202, for reviewing the image that has just been classified, or for proceeding to another image on which the user is to be trained.

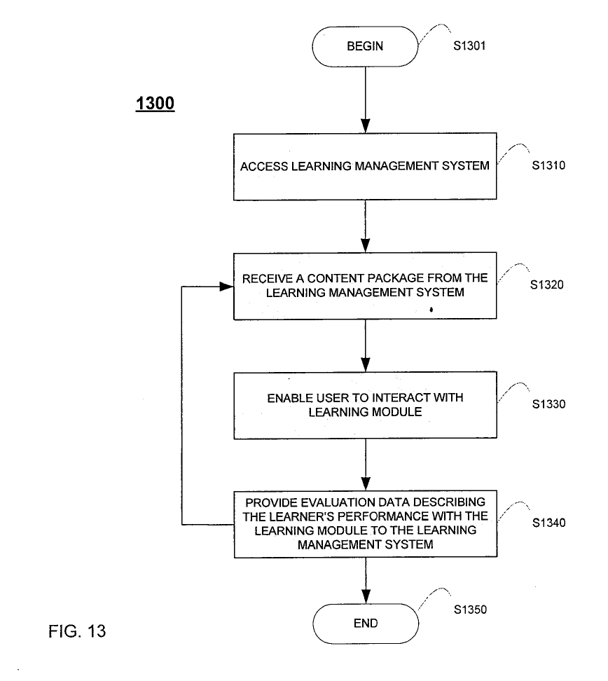

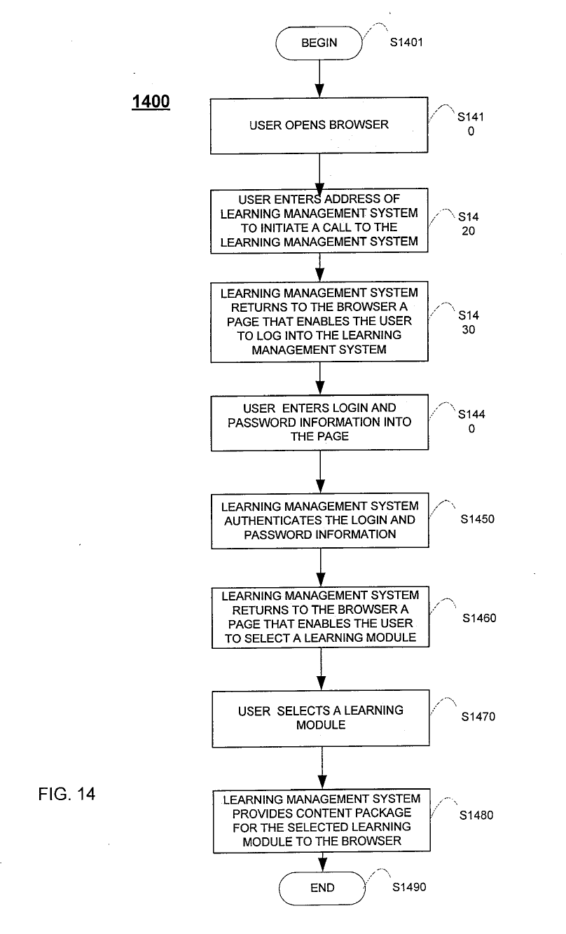

FIG. 13 is a flowchart depicting an example process 1300 for providing image interpretation training to a user, process 1300 being executed by a computer system used by the user to receive the training. Briefly, the process begins (step S1301), and the computer system accesses a LMS (step S1310). The computer system receives a learning module via a content package from the LMS (S1320), enabling the user to interact with the learning module to receive the training (S1330). The computer system provides evaluation data describing the user's performance with the learning module to the LMS (S1340), and the process ends (step S1350). The individual process steps for process 1300 are described in more detail, infra, with respect to FIGS. 14 to 16.

FIG. 14 is a flowchart depicting an example process 1400 for allowing a user to access the LMS. The process begins (step S1401), and a user opens a web browser, such as the MICROSOFT® Internet Explorer web browser or the NETSCAPE® NAVIGATOR® web browser (step S1410) on their individual workstation. The user enters in a web address to initiate a call to the LMS (step S1420). If the LMS is installed on a stand-alone workstation, this call would simply be a local call to the memory medium, such as the hard drive, CD, or DVD, where the content package is stored.

In response to the call, the LMS returns an introductory page, formatted using HTML or another web-enabled code, for displaying content to the browser, where the browser contains a login section that enables the user to log into the LMS (step S1430). The user enters login and password information into the browser, where the data is transmitted to the LMS (step S1440), and the LMS authenticates the user with a local authentication database (step S1450).

If the user is authenticated, the LMS transmits a web page to the browser that includes data for the specific user, such as course progress information (step S1460). The content package is loaded either on a server or the standalone workstation via a network, or a storage device such as a CD or DVD. The content package and/or updates to the content package are added by connecting to a content repository via a network. The user selects a course from the curriculum presented by the LMS (step S1470), the LMS provides a learning module for the selected course via a shareable courseware content package or learning module (step S1480), and the process ends (step S1490).

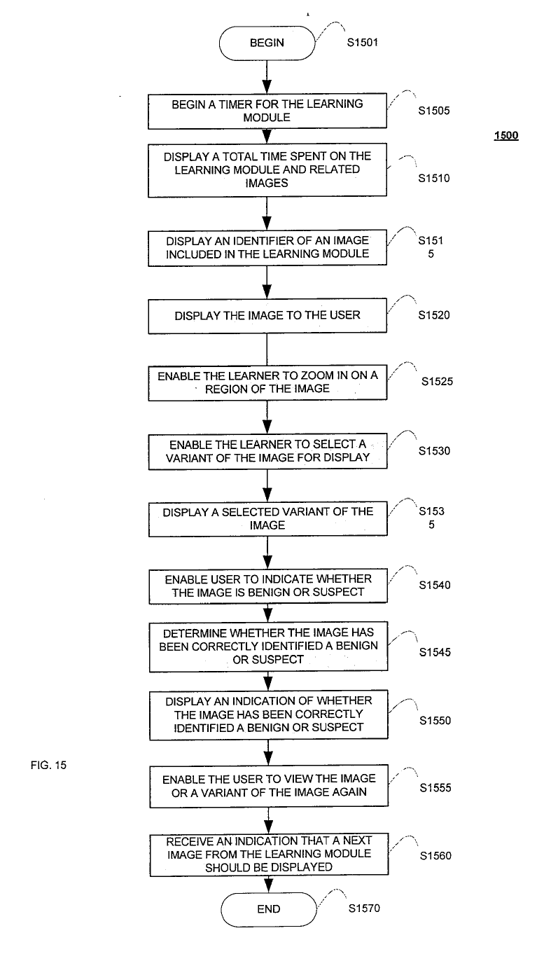

FIG. 15 is a flowchart depicting an example process 1500 for allowing a user to interact with the data encapsulated by the content package. Process 1500 begins (step S1501), and timer is started for an object in a learning module, where the purpose of the image interpretation training is to train a user to interpret each image to determine whether the object within the image is suspect or benign (step S1505). The total allowed or elapsed time for the selected learning module, such as the time allowed or elapsed for the interpretation of a series of objects or images, is also displayed (S1510). A unique identifier, such as an identifier identifying the image to be interpreted is also displayed (step S1515).

The image is displayed to the user (step S1520), such as the case where the user views a base, unprocessed x-ray image to allow for an interpretation or evaluation of whether the item being screened in the image is suspect or benign. The user is enabled to zoom in on particular areas of the image (step S1525). The user is also enabled to display a variant of the base image (step S1530), where the variant of the image is a black and white version, an inverted version, an organic version, or an inorganic version, or other processed variant of the base image. The selected variant of the image is then displayed (step S1535).

The user is enabled to indicate whether the image is benign or suspect (step S1540). If the user interprets the image as benign, where the image is not seen to contain any suspect items, the user signals this by advancing to the next image. If the user interface is simulating a baggage screening the machine, the user would select a control on the user interface ostensibly associated with advancing a conveyer belt to load the next image. If the user interprets the image as suspect, the user selects an appropriate control, such as a “search” control. An evaluation is performed on the user input to determine if the user selected the correct response (step S1545), and an indication of the evaluation is displayed to the user (step S1550).

The user is enabled to choose to review the image they just saw, or a variant of the image (step S1555), where the image reviewed is a standard, photographic (non x-ray) image of the contents, or base image, or variant of the base image. When the user has finished reviewing the image, the user is enabled to view another image of the object or variant image, or is enabled to select the next image or object to be displayed (step S1560). The next image, or an object that includes the next image, is be loaded from the LMS, if necessary, and process 1500 ends (step S1570).

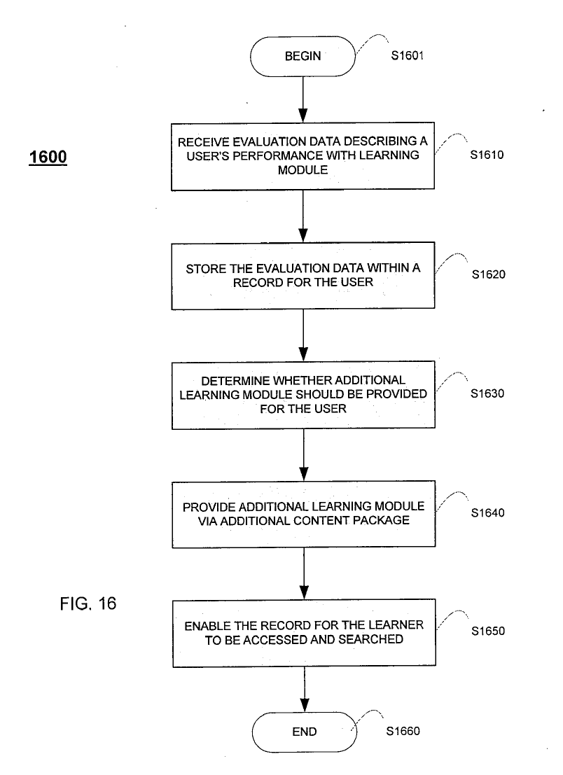

FIG. 16 is a flowchart depicting an example process 1600 executed by a LMS following the receipt of evaluation data by the LMS. The LMS receives evaluation data describing a user's performance with a particular content package (step S1610). The LMS stores the evaluation data in a record for the user (step S1620). If, for example, the LMS is installed on an individual workstation or PC, the data is stored locally.

The LMS determines whether additional content packages should be provided for the user (step S1630) based upon the evaluation data. If additional content package are to be provided, then the LMS identifies and transmits the content packages to the user's workstation (step S1640). If no further training is required, then the LMS indicates that the user has completed the training. The LMS also enable the record for the user to be accessed and searched, for example, to run reports on student activity (step S1650), and the process ends (step S1660).

The image interpretation training described herein caters to security checkpoint personnel, to ensure they know how to interpret x-ray images. Users are able to identify objects as suspect or no threat using imaging equipment. The goals of the providing enhanced image interpretation training are to develop shareable courseware objects, or content packages, to teach security professionals image interpretation skills for use with inspection equipment utilized at security checkpoints, to educate users how to identify both common and threat items, and to create a highly sophisticated shareable courseware template for future use and creation of additional shareable courseware objects. Upon completion of the image interpretation training, users should be able to interpret x-ray images, identify both common and threat items, and identify each image to be either threat or no threat.

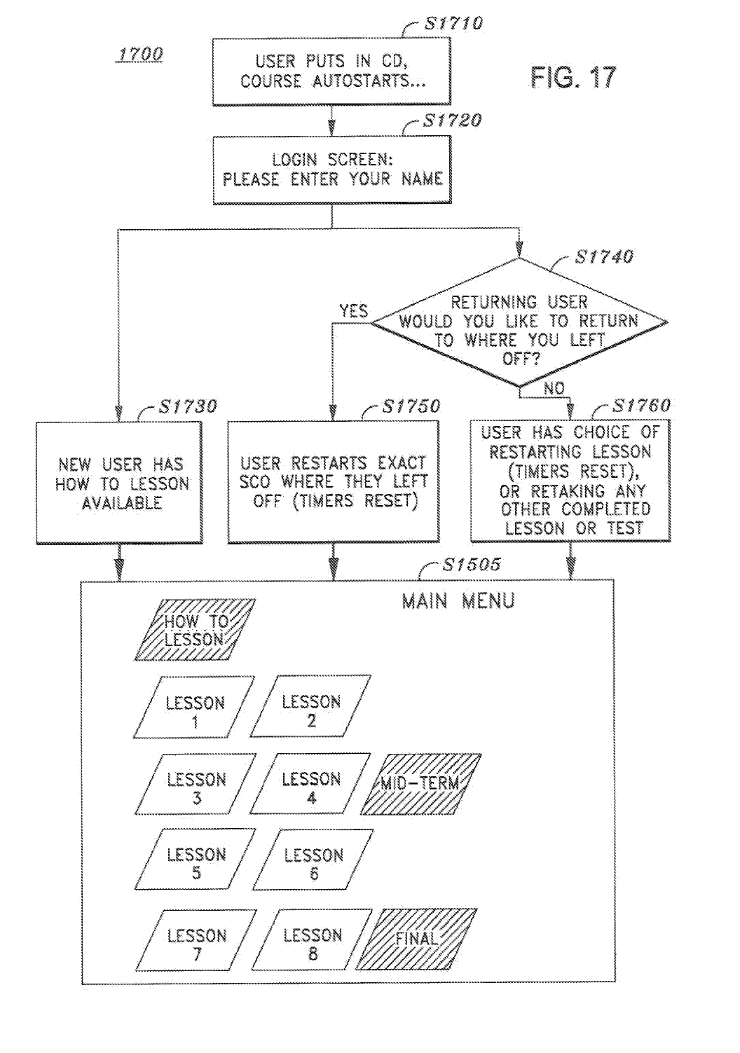

FIG. 17 is a flowchart illustrating process 1700 for providing a user to individual lessons and tests of an image interpretation training learning module. If operating the learning module on a stand-alone workstation, the user begins the learning module by placing media containing the content package into the workstation (step S1710). Once the user logs in to the LMS (step S1720), the learning module launches, and the user is either taken for a tour to the introductory lesson (step S1730), or the user is enabled (step S1740) to resume where they have previously left off in a previous training session (step S1750), depending upon the user login, or to restart the lesson (step S1760). Each user is assigned a user name and password by the administrator of the LMS, so a customized login screen is not required to launch the training.

An introductory lesson is provided as a short tutorial, in a demonstration mode, explaining each part of the user interface. During training, the user selects a control to exit the open window and launch the next lesson from the LMS, since the lessons and test open in a separate window. Upon exiting the learning module, the LMS bookmarks the page, and the LMS prompts or takes the user where he has left off when the user subsequently returns to the learning module.

The user interface includes a ‘help’ control with an iconic question mark to refer to the introductory lesson any point of time, if desired. The introductory lesson opens in an extra window on top of the user interface if selected while the user is currently within a regular lesson or test. The introductory lesson has audio, in English or another language, with one or more narrators or mentors. Narration text exists in the learning module as well as the introductory lesson.

In addition to practice lessons and tests, the learning module includes a mid-term exam and a final exam. The midterm test is administered after the predetermined number of lessons and final exam is administered after the last lesson in the series of learning modules. The lessons and tests are completed in a sequence, in accordance with sequence data. Lessons and tests are not available to a user until a previous learning module has been completed.

Content packages include practice lessons which are interactive, since users are enabled to sequence through the images and determine whether the object is suspect or benign. If the user fails to correct interpret the image, they are shown the correct answer with the appropriate threat identified. A tick-mark or cross over the object provides additional feedback to the user after selecting a control to indicate whether the object is suspect or benign.

The time taken to practice or access each content package is tracked with the help of two on-screen timers, where one timer tracks the elapsed time for each image, and another timer tracks the time elapsed for an entire lesson. An object timer stores individual lesson times, so at the end of the training the LMS can track individual object times and/or cumulative lesson times.

The final examination is be monitored, and results are be stored in the LMS with the content package and lesson timer. The user is enabled to print certificates with score reports at the end of the training the LMS, in a pre-defined or custom format. The certificate of completion is saved in the LMS, so as to allow the user or a mentor to print certificate at any time.

Practice content packages optionally has a time limit. Users are be provided with visual clues, such as a flashing or highlighted timer, at the end of a predetermined period of time, to remind them that they are taking a long time to review an image or the content package.

Each content package includes image data for at least one image, although multiple images are contemplated for enhanced image interpretation training. Once a user indicates that an image is not suspect, a feedback image appears. When shown onscreen, each image has an associated control highlighted on the user interface, where the user is enabled to select the associated control. When in the feedback stage of the training, if the user decides to view at one of the original base or variant images, the user is enabled to select the control, and the image appears in a larger area, with the original thumbnail images returning to a thumbnail size. When the larger area load, the thumbnail images appear darkened.

Each image allows for zooming in/out with a magnifying glass icon, while within the larger area. In one instance, the larger area represents an area of 800 pixels×600 pixels. When user is ready to begin the final examination, a help screen appear notifying the user the rules of the final examination. Upon completing the final examination, the user is given an opportunity to print evaluation data associated with the final evaluation, showing for example the date, test time, and score. Results can be printed at will, since the evaluation data is stored in the LMS and is accessible by LMS user name and password.

It is contemplated that training includes audio cues, such as a “ding” sound for a correct answer or a “buzz” sound for an incorrect answer. Controls displayed seen on the user interface have a rollover effect and/or a soft “click” sound, and are iconic. If the user needs any help regarding the user interface at any point of time, the user is enabled to click on the “Help” control. Such a user interface is helpful to users which are provided to security checkpoint personnel, who often do not have higher education degrees, and are usually hourly employees. These personnel are expected to quickly and accurately identify both common and threat items within scanned items at the security checkpoints through the inspection equipment.

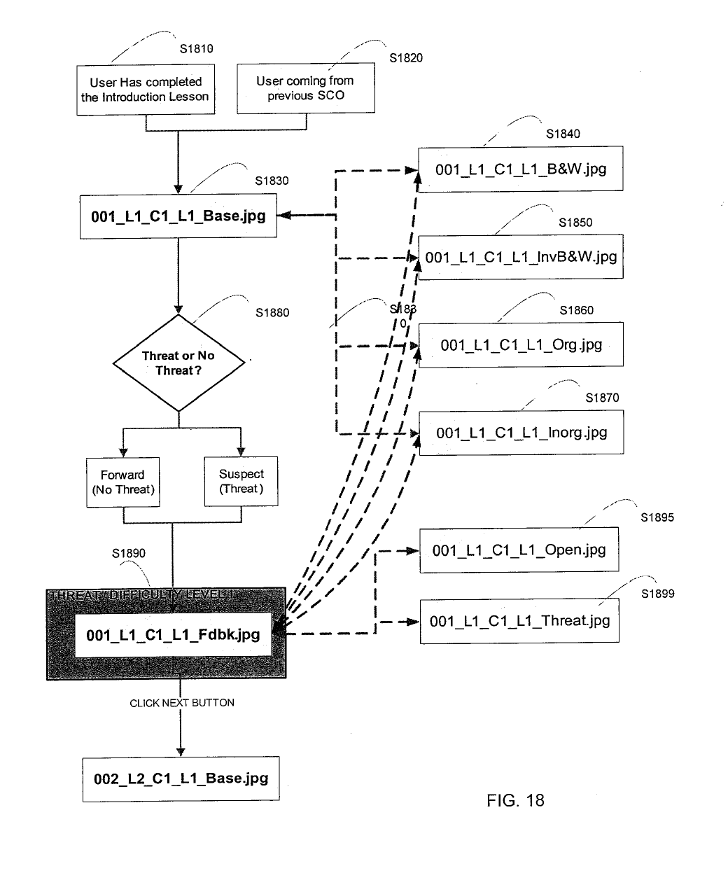

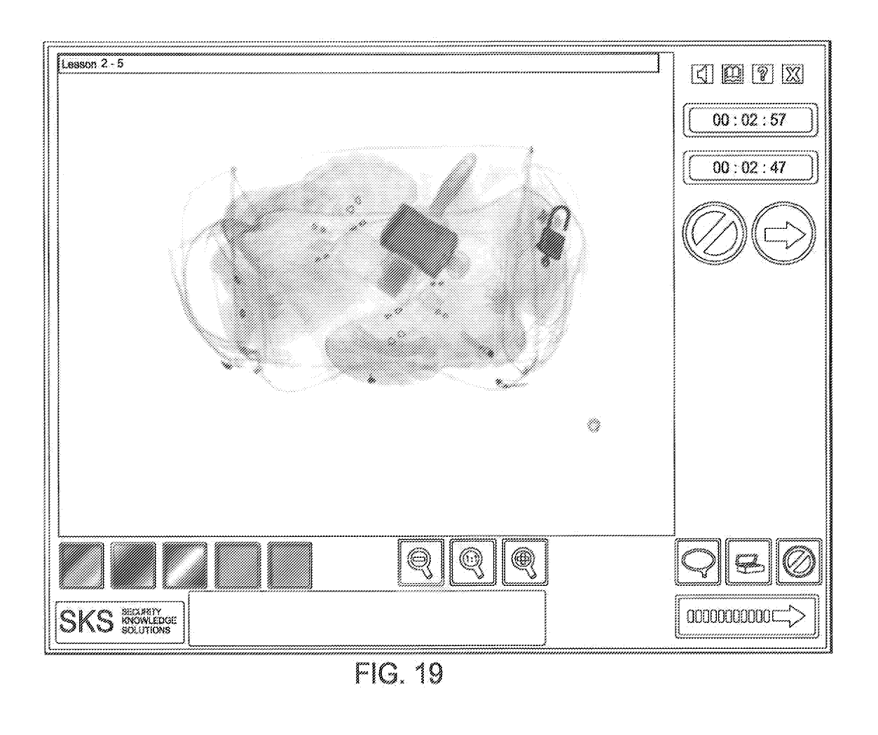

FIG. 18 is a flowchart depicting one example process flow, and corresponding exemplary image data names, associated with the process of providing image interpretation training. Each content package is categorized into multiple threat difficulty levels, with color coded threat levels displayed on the user interface along with the feedback image. Thus the instructional objective is taught using a combination of demonstration, assessment, and feedback. In the demonstration event, a visual sequence is used to show the image. Upon selecting a start control in an introductory lesson (step S1810) or a prior lesson (step S1820), a base image, perhaps entitled “001_L1_C1_L_BASE.JPG” is displayed, and a timer is set. An example of a base image is shown in FIG. 19. Four other varieties of images, black and white version (“001_L1_C1_L1_B&W.JPG”, step S1840), inverse black and white version (“001_L1_C1_L1_INVB&W.JPG”, step S1850), organic version (“001_L1_C1_L1_ORG.JPG”, step S1860), and/or inorganic version (“001_L1_C1_L1_INORG.JPG”, step S1870), are also viewed to better determine whether the object in the image is suspect or benign (step S1880).

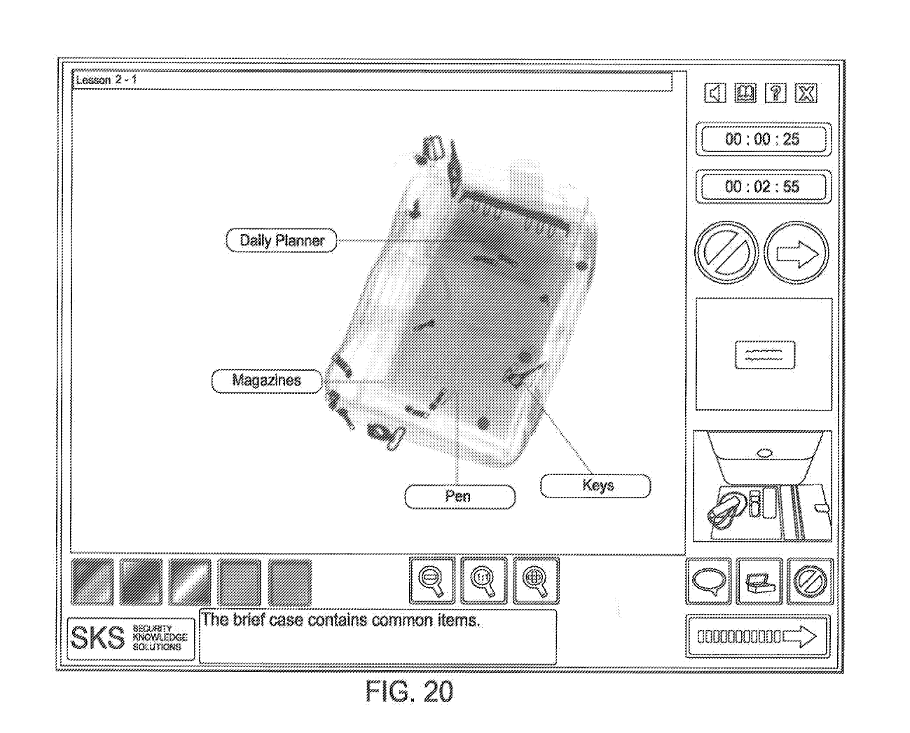

The user is also enabled to click any of the five controls to view any of the versions of the base image again (step S1890). Finally, the user is asked to apply their learning and identify suspect or no threat for this graphic series, and the user interface provides feedback to verify the learner's performance. An example of a feedback image is shown in FIG. 20. The user can click on the a photographic image of the object (“001_L1_C1_L1_OPEN.JPG”, step S1895), or an image of the threat (“001_L1_C1_L1_THREAT.JPG”, step S1899) to evaluate their own interpretation and results.

Although image interpretation training has been described, supra, in the context of training a baggage screener to interpret images produced by an x-ray inspection machines, the these techniques are also germane to images interpretation training for or any other type of output produced by security inspection machines, including for example gamma, neutron, vapor detection scanners, and computer tomography (“CT”) scanners.

Furthermore, the described systems, methods, and techniques are implemented in digital electronic circuitry, computer hardware, firmware, software, or in combinations of these elements. Apparatus embodying these techniques include appropriate input and output devices, a computer processor, and a computer program product tangibly embodied in a machine-readable storage device for execution by a programmable processor. A process embodying these techniques are performed by a programmable processor executing a program of instructions to perform desired functions by operating on input data and generating appropriate output. The techniques are implemented in one or more computer programs that are executable on a programmable system including at least one programmable processor coupled to receive data and instructions from, and to transmit data and instructions to, a data storage system, at least one input device, and at least one output device. Each computer program are implemented in a high-level procedural or object-oriented programming language, or in assembly or machine language if desired; and in any case, the language are a compiled or interpreted language. Suitable processors include, by way of example, both general and special purpose microprocessors. Generally, a processor receives instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (“EPROM”), Electrically Erasable Programmable Read-Only Memory (“EEPROM”), and flash memory devices; magnetic disks such as internal hard disks and removable disks; magneto-optical disks; and CD-ROMs. Any of the foregoing are supplemented by, or incorporated in, specially-designed application-specific integrated circuits (“ASICs”).

It is understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components.

A number of implementations have been described. Nevertheless, it will be understood that various modifications may be made. Accordingly, other implementations are within the scope of the following claims.

What is claimed is:

1. A method for providing image interpretation training to a user, the method comprising:
receiving a shareable courseware content package formatted according to an open-architecture courseware standard, the shareable courseware content package further comprising image data, sequence data, user interface data, and assessment data;
generating a learning module based upon the shareable courseware content package and the open-architecture courseware standard;
displaying user interface data and the image data to the user in accordance with the sequence data;
receiving a user input indicative of a user interpretation of the image data;
evaluating the user input based upon the assessment data, as evaluation data; and
reporting the evaluation data.

2. The method according to claim 1, wherein the open-architecture courseware standard is an Advanced Distributed Learning (“ADL®”) Sharable Content Object Reference Model (SCORM®) standard.

3. The method according to claim 1, wherein the open architecture courseware standard is an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, or a Dublin Core standard.

4. The method according to claim 1, further comprising storing the evaluation data.

5. The method according to claim 1, wherein the shareable courseware content package is formatted using Extensible Markup Language (“XML”).

6. The method according to claim 1, wherein reporting the evaluation data further comprises displaying the evaluation data to the user.

7. The method according to claim 1, wherein reporting the evaluation data further comprises transmitting the evaluation data.

8. The method according to claim 1, wherein the shareable courseware content package further comprises organization data, administrative data, timing data, mastery data, score data, and/or comment data.

9. A learning management device comprising:
a receiver, said receiver receiving a shareable courseware content package formatted according to an open-architecture courseware standard, the shareable courseware content package further comprising image data, sequence data, user interface data, and assessment data, and further receiving a user input indicative of a user interpretation of the image data;
a learning module, said learning module generating a learning module based upon the shareable courseware content package and the open-architecture courseware standard, evaluating the user input based upon the assessment data, as evaluation data, and reporting the evaluation data; and
a user interface, said user interface displaying user interface data and the image data to a user in accordance with the sequence data.

10. The learning management device according to claim 9, wherein the open-architecture courseware standard is an Advanced Distributed Learning (“ADL®”) Sharable Content Object Reference Model (SCORM®) standard.

11. The learning management device according to claim 9, wherein the open architecture courseware standard is an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, or a Dublin Core standard.

12. The learning management device according to claim 9, further comprising a storage unit, said storage unit storing the evaluation data.

13. The learning management device according to claim 9, wherein the shareable courseware content package is formatted using Extensible Markup Language (“XML”).

14. The learning management device according to claim 9, wherein user interface further displays the evaluation data.

15. The learning management device according to claim 9, further comprising a transmitter, said transmitter transmitting the evaluation data.

16. The learning management device according to claim 9, wherein the shareable courseware content package further comprises organization data, administrative data, timing data, mastery data, score data, and/or comment data.

17. A learning management system comprising:
a remote content repository, further comprising:
a remote content repository storage unit, said remote content repository storage unit storing a shareable courseware content package formatted according to an open-architecture courseware standard, the shareable courseware content package further comprising image data, sequence data, user interface data, and assessment data, and
a remote content repository transmitter, said remote content repository transmitter transmitting the shareable courseware content package;
a learning management device, further comprising:
a learning management device receiver, said learning management device receiver receiving the shareable courseware content package and further receiving a user input indicative of a user interpretation of the image data,
a learning module, said learning module generating a learning module based upon the shareable courseware content package and the open-architecture courseware standard, evaluating the user input based upon the assessment data, as evaluation data, and further reporting the evaluation data, and
a learning management device transmitter, said learning management device transmitter transmitting the user interface data and the image data to the user terminal in accordance with the sequence data; and
a user terminal, further comprising:
a user terminal receiver, said user terminal receiver receiving the user interface data and the image data,
a user interface, said user interface displaying user interface data and the image data to a user, and for inputting the user input, and
a user terminal transmitter, said user terminal transmitter transmitting the user input to the learning management device.

18. The learning management system according to claim 17, wherein the open-architecture courseware standard is an Advanced Distributed Learning (“ADL®”) Sharable Content Object Reference Model (SCORM®) standard.

19. The learning management system according to claim 17, wherein the open architecture courseware standard is an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, or a Dublin Core standard.

20. The learning management system according to claim 17, wherein the learning management device further comprises a storage unit, said storage unit storing the evaluation data.

21. The learning management system according to claim 17,
wherein said learning management device transmitter transmits the evaluation data,
wherein said user terminal receiver receives the evaluation data, and
wherein said user interface displays the evaluation data to the user.

22. The learning management system according to claim 17,
wherein said learning management device transmitter transmits the evaluation data,
wherein said remote content repository further comprises a remote content repository receiver, said remote content depository receiver receiving the evaluation data, and
wherein said remote content repository storage unit stores the evaluation data.

23. A data structure by which image interpretation training is provided to a user on a remote learning management system, comprising:
a first component formatted according comprising image data;
a second component comprising sequence data;
a third component comprising user interface data; and
a fourth component comprising assessment data,
wherein the first through fourth components are formatted according to an open-architecture courseware standard.

24. The data structure according to claim 23, further comprising a fifth component comprising organization data, administrative data, timing data, mastery data, score data, and/or comment data.

25. The data structure according to claim 23, wherein the open-architecture courseware standard is an Advanced Distributed Learning (“ADL®”) Sharable Content Object Reference Model (SCORM®) standard.

26. The data structure according to claim 23, wherein the open architecture courseware standard is an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, or a Dublin Core standard.

27. The data structure according to claim 23, wherein the shareable courseware content package is formatted using Extensible Markup Language (“XML”).

28. A computer program product, tangibly stored on a computer-readable medium, for providing image interpretation training to a user, the product comprising instructions to be performed at a learning management device, the instructions operable to cause a programmable processor to:
receive a shareable courseware content package formatted according to an open-architecture courseware standard, the shareable courseware content package further comprising image data, sequence data, user interface data, and assessment data;
generate a learning module based upon the shareable courseware content package and the open-architecture courseware standard;
display user interface data and the image data to a user in accordance with the sequence data;
receive a user input indicative of a user interpretation of the image data;
evaluate the user input based upon the assessment data, as evaluation data; and
report the evaluation data.

29. The computer program product according to claim 28, wherein the open-architecture courseware standard is an Advanced Distributed Learning (“ADL®”) Sharable Content Object Reference Model (SCORM®) standard.

30. The computer program product according to claim 28, wherein the open architecture courseware standard is an Aviation Industry Computer-Based Training (“CBT”) Committee (“AICC®”) standard, an Institute of Electrical and Electronics Engineers (“IEEE®”) Learning Technology Standards Committee (“LTSC”) standard, an Instructional Management System (“IMS”) Global Learning Consortium standard, a Promoting Multimedia Access to Education and Training in European Society (“PROMETEUS”) standard, or a Dublin Core standard.

31. The computer program product according to claim 28, wherein the instructions are further operable to cause the programmable processor to store the evaluation data.

32. The computer program product according to claim 28, wherein the instructions are further operable to cause the programmable processor to display the evaluation data to the user.

33. The computer program product according to claim 28, wherein the instructions are further operable to cause the programmable processor to transmit the evaluation data.

34. The computer program product according to claim 28, wherein the shareable courseware content package further comprises organization data, administrative data, timing data, mastery data, score data, and/or comment data.
